(19) United States
(12) Patent Application Publication
(10) Pub. No.: US 2003/0063869 A1
(43) Pub. Date: Apr. 3, 2003

(54) Module attachment for securing at least one optical waveguide and methods therefor

(76) Inventors: Robert B. Elkins II, Hickory, NC (US); Lars K. Nielsen, Hickory, NC (US)

Correspondence Address: CORNING CABLE SYSTEMS LLC, P O BOX 489, HICKORY, NC, 28603, US

(21) Appl. No.: 10/288,840

(22) Filed: Nov. 6, 2002

Related U.S. Application Data
(63) Continuation-in-part of application No. 09/681,603, filed on May 7, 2001.

(51) Int. Cl. G02B 6/36

(52) U.S. Cl. 385/87

(57) ABSTRACT

An optical waveguide module attachment includes a cushioning element and a body. The cushioning element is configured for positioning about at least one optical waveguide, thereby forming a clamping portion for protecting the at least one optical waveguide from clamping forces applied by the body. The body has a passage therethrough with predetermined dimensions for passing a clamping portion of at least one optical waveguide therein. The body can be crimped thereby applying clamping forces to the clamping portion for securing the at least one optical fiber thereto. In other embodiments, the clamping forces can be applied to the body using a clamping portion or element.

### RELATED APPLICATIONS

The present invention is a Continuation-In-Part (CIP) of U.S. patent application Ser. No. 09/681,603 filed on Jun. 21, 2001, which is incorporated herein by reference.

### FIELD OF THE INVENTION

The present invention relates generally to a module attachment for securing at least one optical waveguide. More specifically, the invention relates to a module attachment for securing at least one optical waveguide, thereby inhibiting forces acting on the optical waveguide from being transferred beyond the module attachment.

### BACKGROUND OF THE INVENTION

Optical modules, or devices, can include optical pathways such as optical fibers that transmit optical signals such as voice, video, and/or data information. These optical pathways within the optical modules can require optical connection with other optical devices. For example, optical connectivity requires optical waveguides to enter, or exit, the device. For proper operation of the optical module, the quality of the optical connection must be maintained. Therefore, the optical waveguide must be reliably and sturdily attached to the optical module so that optical signals are preserved and properly transferred.

### SUMMARY OF THE INVENTION

The present invention is directed to an optical waveguide module attachment including a body and a clamping element. The body has a passage therethrough and a first cantilevered portion and a second cantilevered portion. The clamping element is configured for engaging the first and second cantilevered portion of the body.

The present invention is also directed to an optic waveguide module attachment including a body and a clamping portion. The body includes a first portion and a second portion and the clamping portion is configured for securing a clamping zone between the first and the second portions.

The present invention is further directed to a module attachment for securing at least one optical waveguide to a device including a cushioning element and a body. The cushioning element is configured for positioning about the at least one optical waveguide, thereby forming a clamping portion for protecting the at least one optical waveguide from clamping forces applied by the body. The body has a passage therethrough with predetermined dimensions for passing a clamping portion of at least one optical waveguide therein, wherein the body can function to apply clamping forces to the clamping portion.

The present invention is also directed to a module attachment assembly including a body having a passage therethrough, a cushioning member, and at least one optical waveguide. The at least one optical waveguide has a predetermined clamping portion with the cushioning member disposed about the predetermined clamping portion. The predetermined clamping portion is at least partially disposed within the passage with the body being secured to the clamping portion, thereby inhibiting clamping forces from degrading optical performance of the at least one optical waveguide.

The present invention is still further directed to a method of securing at least one optical waveguide to a module attachment including providing at least one optical waveguide and a module attachment having at least one cushioning member and a body with a passage therethrough. Positioning the at least one cushioning member about a portion of the at least one optical waveguide, thereby forming a clamping portion of the at least one optical waveguide. Inserting the clamping portion of the at least one optical waveguide into the passage of the body. Then, securing the body to the at least one cushioning member and at least one optical waveguide, thereby inhibiting movement between the body and the at least one optical waveguide.

### BRIEF DESCRIPTION OF THE FIGS.

FIG. 1 is a cutaway view of a module attachment connected to a panel according to one embodiment of the present invention.

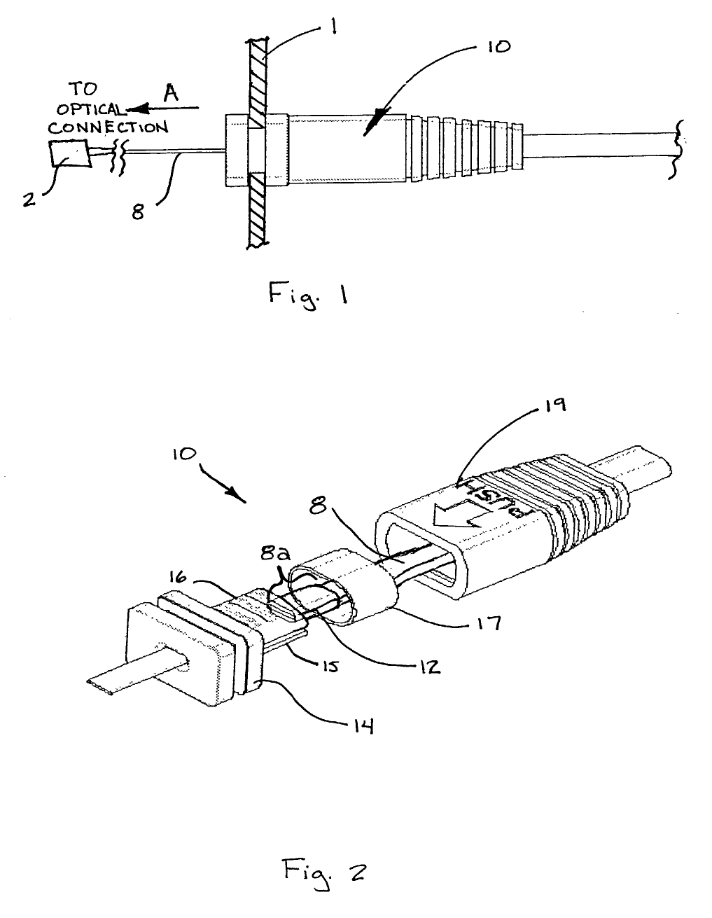

FIG. 2 is a partially exploded perspective view of the module attachment of FIG. 1.

FIG. 3 is a perspective view of the body of the module attachment of FIG. 1.

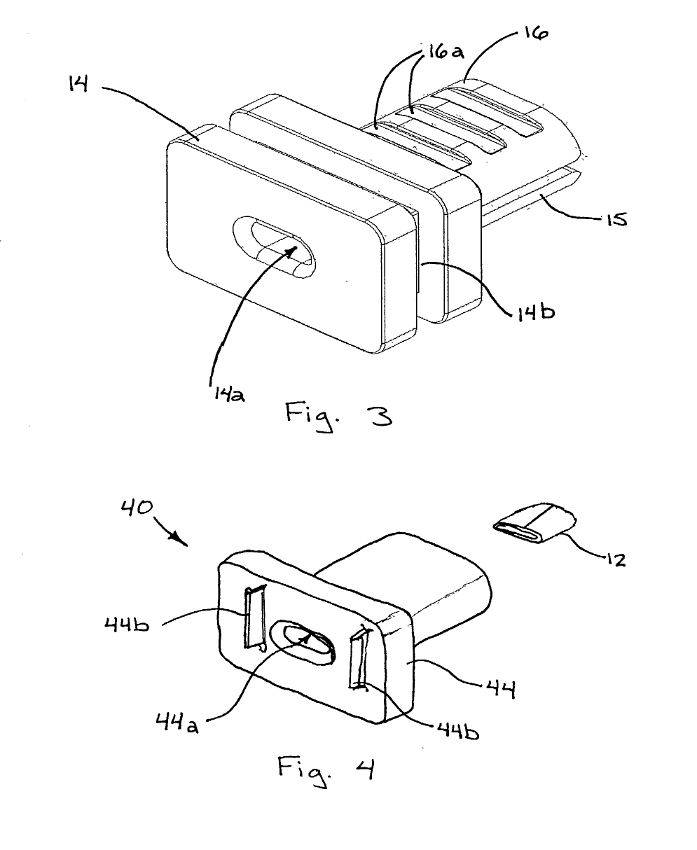

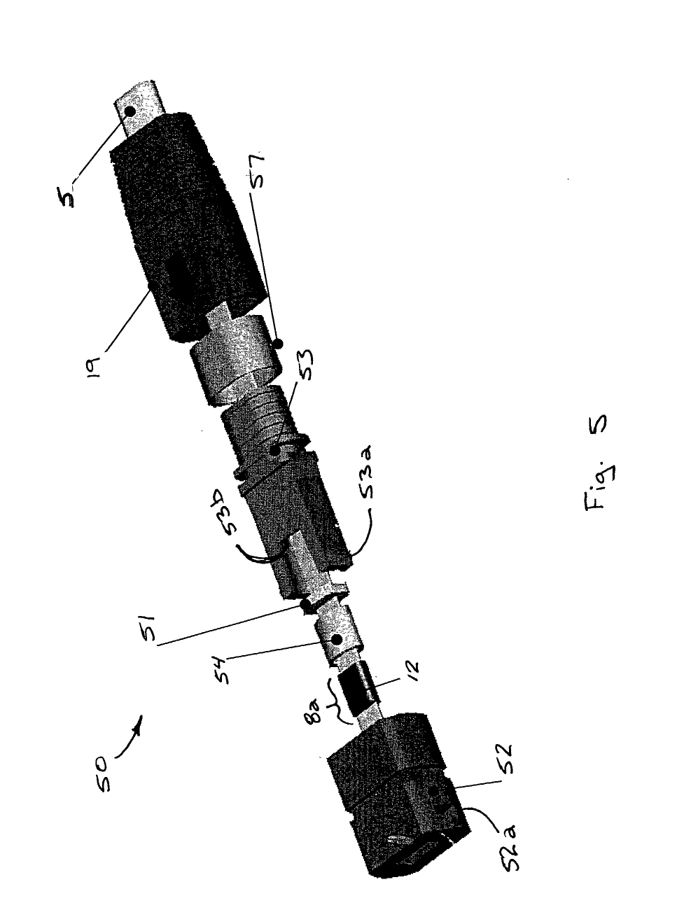

FIG. 4 is an exploded perspective view of another module attachment according to the present invention.

FIG. 5 is a partially exploded, partially assembled, perspective view of another embodiment according to the present invention.

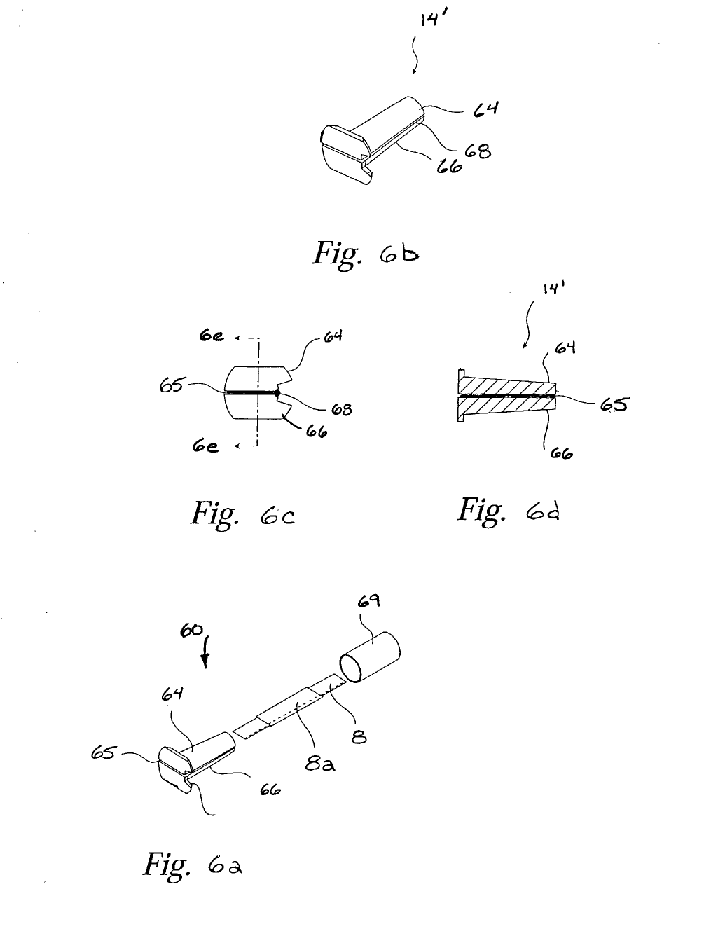

FIG. 6a is a partially exploded perspective view of another ribbon mechanical attachment according to the present invention.

FIGS. 6b-6d are respectively a perspective view, an elevation view, and a cross-sectional view of the body of FIG. 6a.

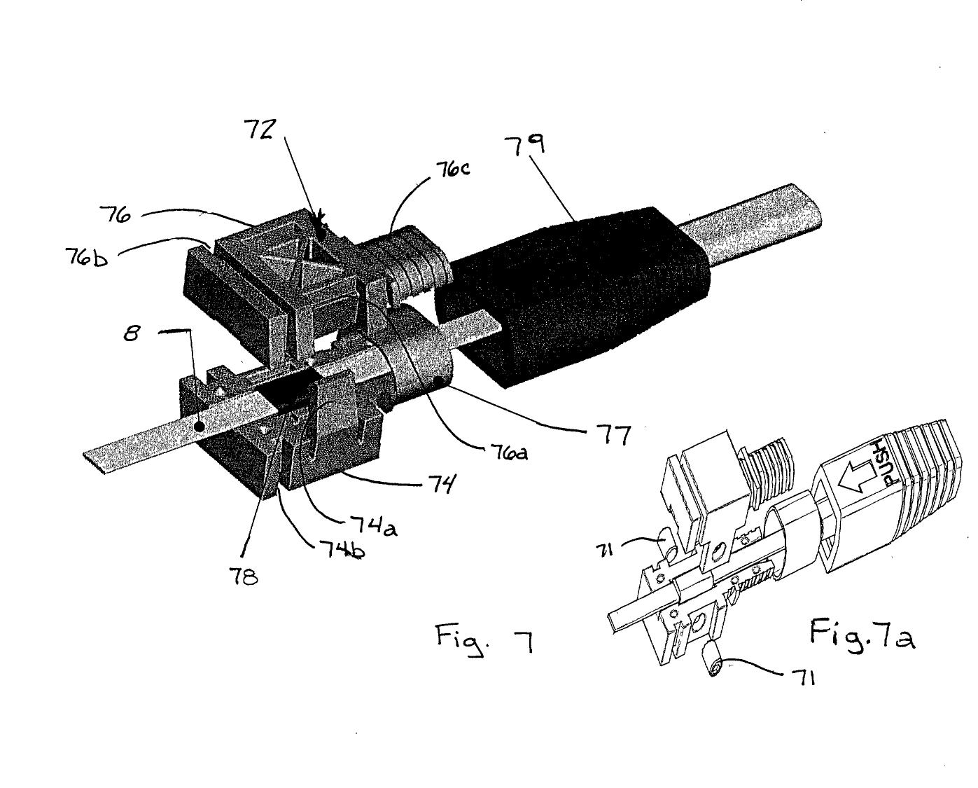

FIG. 7 is a partially exploded, partially assembled, perspective view of another module attachment according to the present invention.

FIG. 7a is a partially exploded, partially assembled, perspective view of another module attachment according to the present invention.

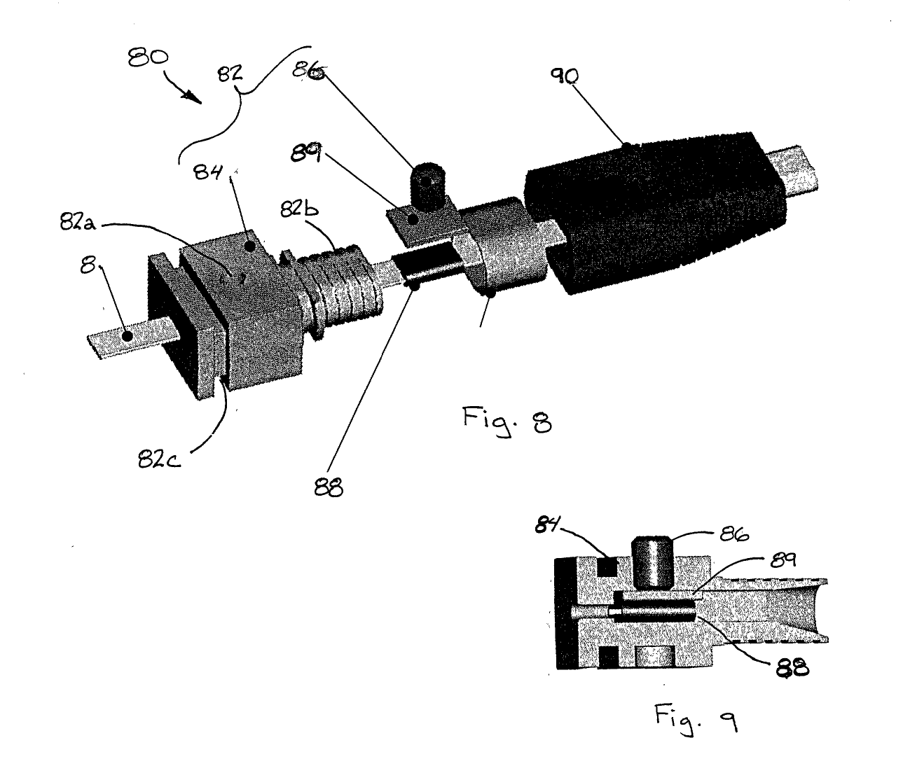

FIG. 8 is a partially exploded, partially assembled, perspective view of another module attachment according to the present invention.

FIG. 9 is a partial assembled cross-sectional view of the module attachment of FIG. 8.

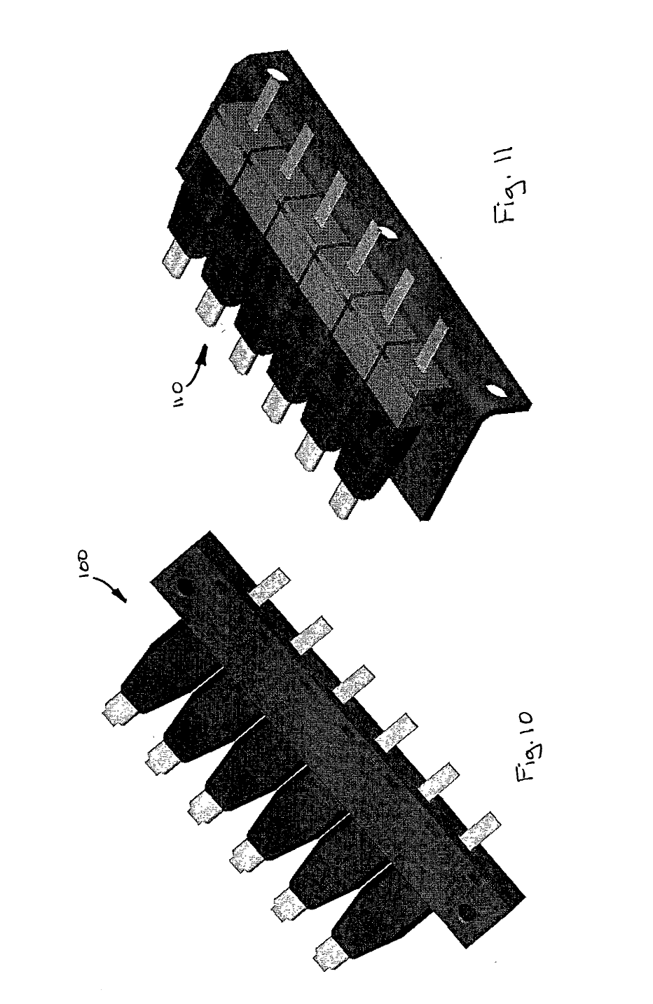

FIGS. 10 and 11 are perspective views of a plurality of module attachments in a gang configuration.

### DETAILED DESCRIPTION OF THE INVENTION

Illustrated in FIG. 1 is an exemplary module attachment 10 according to one embodiment of the present invention. As depicted module attachment is attached to, for instance, a panel 1 of an optical module, or device, having optical components therein. At least one optical waveguide 8, for example, an optical fiber ribbon enters the optical module using module attachment 10. Panel 1 of the optical module does not form a part of the present invention; rather, it provides a mounting location for the module attachment 10. For instance, applications can require optical fibers in a ribbon structure to enter an optical module, as depicted by arrow A, for optical connection therein by an optical connector 2. However, the application requires that external forces such as tension loads not be transferred by optical waveguides(s) 8 to the optical components/connections within the optical module. Module attachments of the present invention secure at least one optical waveguide such as optical fiber(s) and/or optical fiber ribbon(s) that enter an optical module and inhibit external forces from being transferred past the module attachment into the optical module. Preferred embodiments of the present invention exclude the use of epoxies and/or adhesives; however, the same can be used with the concepts of the present invention. Additionally, the present invention should not be confused with optical connectors that optically couple optical waveguides. Instead, module attachments of the present invention secure at least one optical waveguide at a medial portion thereof. Additionally, preferred embodiments of the present invention secure optical waveguides in a clamping zone of a module attachment body; however, other additional components such as strength members can be secured, thereby providing a robust configuration.

FIG. 2 illustrates a partially exploded perspective view of module attachment 10. Module attachment 10 includes a cushioning element 12, a body 14, a clamping element 17, and a boot 19. In use, cushioning element 12 is positioned about a predetermined portion of at least one optical waveguide 8 such as a fiber optic ribbon (hereinafter ribbon), thereby forming a clamping portion 8a of optical waveguide 8. Body 14 has passage 14a therethrough (FIG. 3) that continues through to a first cantilevered portion 15 and a second cantilevered portion 16. Cantilevered portions 15, 16 form a clamping zone therebetween. Optical waveguide 8 is inserted into passage 14a from the cantilevered side until clamping portion 8a is disposed between first and second cantilevered portions 15,16 of body 14, i.e., the clamping zone. Thereafter, clamping element 17, more specifically, a crimp ring engages first and second cantilevered portions 15, 16 so that portions 15,16 are at least partially within the crimp ring. The crimp ring can then be crimped so that cantilevered portions 13,14 are biased together, thereby securing the optical waveguide by applying a clamping force to clamping portion 8a that inhibits relative movement between body 14 and optical waveguide 8.

Cushioning element 12 preserves optical performance of optical waveguide 8 by providing a relatively soft cushioning/compressible material between optical waveguide 8 and the clamping portion or element. Preferably, cushioning element is formed from a resilient material. Thus, when the clamping force is applied it is more uniformly distributed to optical waveguide 8. Cushioning element 12 has predetermined dimensions so that it fits about the selected optical waveguide 8, but still can fit within the clamping zone of cantilevered portions 15,16. In other embodiments, cushioning element 12 can be sized for placement about a plurality of optical waveguides such as ribbons or bundles. Preferably, cushioning element is an elastomeric material such as Krayton® formed as collar that slides over optical waveguide 8; however, other suitable shapes and/or materials such as a collar having a slitcan be used. Moreover, cushioning element 12 is only required on the portion of the optical waveguide where the force is directly applied; however, preferred embodiments use a cushioning element over the entire optical waveguide portion experiencing clamping forces.

As depicted in FIG. 3, body 14 includes passage 14a and an attachment feature 14b. Body 14 can use suitable materials for portions thereof such as dielectrics, metals, composite materials or combinations thereof. For instance, a metal body can be machined using known machining techniques or a dielectric material can be injected molded. Passage 14a has predetermined dimensions for receiving at least one optical waveguide 8 therethrough; however, the dimensions can be configured for more than one optical waveguide such as a plurality of ribbons, or a bundle to extend therethrough. As depicted, this embodiment includes a first cantilevered portion 15, and a second cantilevered portion 16 extending from body 14. Cantilevered portions 15,16 are spaced apart so that clamping portion 8a can fit therebetween. Additionally, the clamping zone of passage 14a can have an inner surface such as teeth, rings, or bumps, thereby providing resistance to movement of the optical waveguide. Attachment feature 14b is used for mounting body 14 of module attachment 10 (FIG. 1). Attachment feature 14b can be any suitable feature; for instance, as shown body 14 has at least one groove that fits within a panel wall. The groove is formed by two spaced apart shoulders. Other suitable attachment features 14b can also be used such as a resilient member (FIG. 4) for securing the body to a mounting location. Other attachment features can include a single shoulder that is screwed to a panel.

Additionally, cantilevered portions 15, 16 may include one or more grooves 16a,15a (not numbered) for securing strength members (not shown) of a fiber optic cable. By way of example, a fiber optic cable can have a portion of its jacket and strength members removed. Thereafter, cushioning element 12 is located at clamping portion 8a and inserted between cantilevered portions 15,16. The remaining portions of the strength members are bent back and disposed generally on the outer surfaces of cantilevered portions 15,16, preferably adjacent grooves 15a,16a. When clamping element 17 such as a crimp ring engages cantilevered portions 15,16 the strength members are trapped therebetween. Consequently, when crimp ring is crimped the strength members are secured to body 14. Thus, forces applied to the fiber optic cable are transferred to body 14 through the strength members and then to the mounting surface of the module attachment; rather, than to the optical components/connections within the optical module.

Module attachment 10 also includes boot 19 for providing strain relief to the optical fiber ribbon and/or optical fiber cable. Boot 19 can be formed from any suitable material such as polymeric materials. Boot 19 preferably has a bend relief portion 19a and is configured for attachment with body 14 using suitable means such as a friction fit, resilient members, or adhesives. Additionally, other bend relief elements can be used such as a heat shrink sleeve.

The concepts of the present invention can be practiced in other embodiments. For instance, depicted in FIG. 4 is module attachment 40 another embodiment according to the present invention. Module attachment 40 includes a cushioning element 12 and a body 44. Body 44 includes a passage 44a therethrough and an optional attachment feature 44b. Cushioning element 12 has a slit (not numbered) and fits about optical waveguide 8, thereby forming clamping portion 8a. Passage 44a has predetermined dimensions suitable for inserting the clamping portion 8a within passage 44a. In this embodiment, body 44 also functions as a clamping element. In other words, after clamping portion 8a is in position relative to passage 44a, body 44 can be crimped, thereby applying a clamping force to clamping portion 8a to secure the same. Additionally, in this embodiment a per se attachment feature 44b and/or the flange are not necessary. Stated another way, the outer surface of body 44 can function as an attachment feature having a locking or friction fit. For example, body 44 can be secured by trapping end faces in a lengthwise direction or by using the transverse cross-sectional outer surface as a friction-fit within an aperture. However, as depicted, body 44 includes attachment feature 44b, more specifically, body 44 includes at least one resilient member that is deflected during installation and is biased outward after full insertion into a suitably sized aperture, thereby securing body 44. However, any other suitable attachment features can be used such as quarter-turn locking features. Moreover, body 44 can be formed from any suitable materials.

FIG. 5 illustrates another embodiment according to the present invention. Module attachment 50 is intended to secure a cable 5 thereto. Module attachment 50 includes a cushioning element 12, a retainer 51, a housing 52, a spring push 53, a body 54, a crimp ring 57, and a boot 19. As described in the previous embodiment, body 54 is capable of applying a clamping force to clamping portion 8a, thereby securing the optical waveguides. In this particular embodiment, the end faces of body 54 are trapped between retainer 51 and an internal surface (not shown) of housing 52.

During assembly, a suitable portion of the jacket and strength members of cable 5 are stripped therefrom and boot 19, crimp ring 57, spring push 53, retainer 51, and cushioning element 12 are pushed onto the ribbon/cable. Next, cushioning element is located at clamping portion 8a and body 54 is secured thereto. Thereafter, retainer 51 can be positioned to abut the rear face of body 54 and a backstop surface 53b of spring push 53 abuts the other side of retainer 51. The strength members of cable 5 are then positioned on the grooved portion of spring push 53, thereafter crimp ring 57 is position thereover and crimped, thereby providing strain relief to the cable. Spring push 53 can then be removably attached to housing 52 by having resilient members 53a engage notches 52a in the housing 52 in a snap-fit arrangement. Thereafter, boot 19 can be attached to the rear of spring push 53. Housing 52 can include attachment features thereon for mounting the module attachment. Moreover, other housings configured for a plurality spring pushes can be used (FIGS. 10 and 11).

FIGS. 6a-6d illustrate concepts of module attachment 60 using a body 14′ having hinged portions. Body 14′ includes a first portion 64 and a second portion 66 with opposing surfaces connected by a hinge 68, such as a living hinge that form a clamping zone therebetween. Clamping can be provided by a clamping portion 69, or element, such as a compression sleeve, thereby securing the at least one optical fiber between hinged portions 124,126. Furthermore, one or both of the opposing surfaces of hinged portions 124,126 can include a cushioning element 125 thereon. Some examples include foams, rubbers, or other suitable compressible materials. Also as discussed above, positioning the cushioning element about the optical waveguide is also possible. The hinged portions 124,126 can include other suitable clamping portions that are integral with the body such as snapping tabs, resilient members; however, other components such as wire ties are suitable for securing hinged portions 124,126 together, thereby clamping the optical fiber(s). Although, the depicted embodiment includes a shoulder other embodiments can have other suitable shapes and/or configurations.

Other suitable embodiments include hinged portions having profiles other than generally planar. For example, profiles in a plastic hinge body can form a cylindrical passage through the same, thereby allowing clamping of a bundle of optical waveguides. Additionally, other configurations can include first and second portions not hinged together.

FIG. 7 illustrates exemplary concepts of a body 72 including first and second portions 74,76 that engage each other. As shown, first portion 74 includes at least one resilient portion 74a that cooperates with a respective notch 76a formed on second portion 76, thereby securing at least one optical fiber in a clamping zone between the portions. Moreover, the first and second portions 74,76 can include alignment features (not numbered). Like other embodiments, cushioning elements 78 can be placed in any suitable location and/or the portions can have profiled surfaces for bundles as well as generally planar surfaces for optical waveguides such as optical fibers/ribbons.

In other embodiments, clamping forces can be applied using a clamping element 77 such as a crimp ring. Other embodiments could use both integral and discrete clamping portions for applying clamping forces. Additionally, embodiments shown and variations thereof can include boots 79 for bend relief, attachment features 74b,76b for securing body 72, or grooves 74c,76c for securing strength members for strain relief. Illustrated in FIG. 7a is an embodiment that is similar to FIG. 7, except that FIG. 7a employs a pair of screws 71 to hold the first and second portions together.

Other concepts of the present invention include other suitable clamping portions and/or elements. FIG. 8 illustrates an exemplary embodiment 80 using a two-portion body 82 for advancing a clamping portion disposed in a clamping zone thereof. Specifically, body 82 includes a body block 84 and a screw 86 cooperating with a bore 82a in body 82 that is capable of advancing a plate 89 for applying a generally uniform clamping force. Like other embodiments, variations include bend relief such as boot 90, grooves 82b, attachment features 82c, cushioning elements 88, and/or one or more clamping portions integral with body 82 or elements such as a crimp ring. FIG. 9 depicts a partial cross-section of module attachment 80 of FIG. 8. As shown, the clamping force of on clamping portion 8a of optical waveguides 8 secures the same. In other embodiments, the body can include more than two-portions. FIGS. 10 and 11 illustrates embodiments 100 and 110 that gang together a plurality of module attachments according to other concepts of the present invention.

Many modifications and other embodiments of the present invention, within the scope of the appended claims, will become apparent to a skilled artisan. For example, bodies of the present invention can be electrical/optical composite module attachments while still employing the concepts of the present invention. Moreover, other configurations of module attachments using the concepts of the present invention can be made waterproof and/or vibration resistant for special applications. Therefore, it is to be understood that the invention is not to be limited to the specific embodiments disclosed and that modifications and other embodiments may be made within the scope of the appended claims. Although specific terms are employed herein, they are used in a generic and descriptive sense only and not for purposes of limitation. The invention has been described with reference to ribbons; however, the inventive concepts of the present invention are applicable to other suitable variations. Including a plurality of ribbons in a stack or a buffer tube passing through the body. Furthermore, several ribbon stacks can be individually bundled for securing at the body.

That which is claimed:

1. An optical waveguide module attachment comprising:
a body having a passage therethrough, the body having a first cantilevered portion and a second cantilevered portion; and
a clamping element, the clamping element being configured for engaging the first and second cantilevered portion of the body.

2. The optical waveguide module attachment according to claim 1, the clamping element being a crimp ring.

3. The optical module attachment according to claim 1, the body having at least one attachment feature configured for mounting the body.

4. The optical waveguide module attachment according to claim 4, the at least one attachment feature being a groove.

5. The optical waveguide module attachment according to claim 3, the at least one attachment feature being a resilient member.

6. The optic waveguide module attachment according to claim 1, further comprising a cushioning element configured for placement about at least one optical waveguide, thereby cushioning the at least one optical waveguide from clamping forces.

7. The optic waveguide module attachment according to claim 1, further comprising a boot configured for attachment with the body, the boot having a bend relief portion.

8. The optical waveguide module attachment according to claim 1, the body having a portion made from the group selected from of a dielectric and a metal.

9. The optical waveguide module attachment according to claim 1, further comprising a fiber optic ribbon disposed between the first and second cantilevered portions.

10. The optical waveguide module attachment according to claim 1, further comprising a portion of a gang assembly.

11. A optic waveguide module attachment comprising:
a body, the body having a first portion and a second portion; and
a clamping portion, wherein the clamping portion is configured for securing a clamping zone between the first and the second portions.

12. The optical waveguide module attachment according to claim 11, the first and section portions being configured to engage each other.

13. The optical waveguide module attachment according to claim 11, the clamping portion being a resilient element disposed on one of the portions.

14. The optical waveguide module attachment according to claim 11, the body further comprising a hinge, the hinge connecting the first and second portions, thereby permitting the first and second portions to rotate into a clamping position.

15. The optical waveguide module attachment according to claim 11, the first portion of the body having a bore and the second portion of the body being a screw that fits into the bore.

16. The optical waveguide module attachment according to claim 15, the clamping portion being a plate for distributing the force applied by the screw.

17. The optical waveguide module attachment according to claim 11, the clamping portion being a crimp ring that engages the first and the second portions.

18. The optical waveguide module attachment according to claim 11, the clamping element being a screw for attaching the first portion to the second portion.

19. The optical waveguide module attachment according to claim 11, the body having at least one attachment feature configured for mounting the body.

20. The optical waveguide module attachment according to claim 19, the at least one attachment feature being a groove.

21. The optical waveguide module attachment according to claim 19, the at least one attachment feature being a resilient member.

22. The optical waveguide module attachment according to claim 11, further comprising a cushioning element for protecting the optic waveguide from clamping forces.

23. The optical waveguide module attachment according to claim 22, the cushioning element attached to a portion of the body.

24. The optical waveguide module attachment according to claim 11, further comprising a boot configured for attachment with the body, the boot having a bend relief portion.

25. The optical waveguide module attachment according to claim 11, the body having a portion made from a material selected from the group of a dielectric and a metal.

26. The optical waveguide module attachment according to claim 11, further comprising a fiber optic ribbon disposed between the first and second portions.

27. A module attachment for securing at least one optical waveguide to a device, comprising:
a cushioning element, the cushioning element being configured for positioning about the at least one optical waveguide, thereby forming a clamping portion for protecting the at least one optical waveguide from clamping forces applied by the body;
a body having a passage therethrough, the passage having predetermined dimensions for passing a clamping portion of at least one optical waveguide therein, wherein the body can function to apply clamping forces to the clamping portion.

28. The module attachment of claim 27, the body having at least one attachment feature configured for mounting the body.

29. The module attachment according to claim 28, the at least one attachment feature being a groove.

30. The module attachment according to claim 28, the at least one attachment feature being a resilient member.

31. The module attachment according to claim 27, further comprising a boot configured for attachment with the body, the boot having a bend relief portion.

32. The module attachment according to claim 27, the body having a portion made from the group selected from of a dielectric and a metal.

33. A module attachment assembly comprising:
a body, the body having a passage therethrough;
a cushioning member;
at least one optical waveguide, the at least one optical waveguide having a predetermined clamping portion, the cushioning member disposed about the predetermined clamping portion, the predetermined clamping portion being at least partially disposed within the passage, the body being secured to the clamping portion, thereby inhibiting clamping forces from degrading optical performance of the at least one optical waveguide.

34. The module attachment assembly according to claim 33, the assembly further comprising at least one optical fiber connector attached to the at least one optical waveguide.

35. The module attachment of claim 33, the body having at least one attachment feature configured for mounting the body.

36. The module attachment according to claim 35, the at least one attachment feature being a groove.

37. The module attachment according to claim 35, the at least one attachment feature being a resilient member.

38. The module attachment according to claim 33, the at least one optical waveguide comprising a fiber optic ribbon.

39. A method of securing at least one optical waveguide to a module attachment comprising:
providing at least one optical waveguide and a module attachment comprising at least one cushioning member and a body having a passage therethrough;
positioning the at least one cushioning member about a portion of the at least one optical waveguide, thereby forming a clamping portion of the at least one optical waveguide;
inserting the clamping portion of the at least one optical waveguide into the passage of the body; and
securing the body to the at least one cushioning member and at least one optical waveguide, thereby inhibiting movement between the body and the at least one optical waveguide.

40. The method according to claim 39, further comprising attaching an optical connector to the at least one optical waveguide.

41. The method according to claim 39, the at least one optical waveguide being a portion of an optical fiber ribbon.
